(19) United States
(12) Patent Application Publication
(10) Pub. No.: US 2024/0338425 A1
(43) Pub. Date: Oct. 10, 2024

(54) COMPUTER-BASED SYSTEMS CONFIGURED TO ORCHESTRATE A TRANSFER OF A DIGITAL ARTIFACT AND METHODS OF USE THEREOF

(71) Applicant: Broadridge Financial Solutions, Inc., Newark, NJ (US)

(72) Inventors: Sangeeth Rao, Newark, NJ (US); Ramchand Swarna, Newark, NJ (US); Terry Ashby, Newark, NJ (US); Randall Stafford, Newark, NJ (US); RajSekhar Reddygari, Newark, NJ (US); Krishna Hegde, Newark, NJ (US); Jeffery Price, Newark, NJ (US); Lee Kenyon, Newark, NJ (US); Nehal Patel, Newark, NJ (US); Mark Stanton, Newark, NJ (US); Joe Rottenberg, Newark, NJ (US); Vijay Bandaru, Newark, NJ (US); Jeffrey Klein, Newark, NJ (US); Mitchell Herman, Newark, NJ (US); Otto Heilmann, Newark, NJ (US); Julie Hodum, Newark, NJ (US); Michael Ward, Newark, NJ (US); Michael Speed, Newark, NJ (US); Tim Profitt, Newark, NJ (US); Angelo Riccio, Newark, NJ (US); Steven Pirella, Newark, NJ (US); Pat Scaglione, Newark, NJ (US); Michael Stallmeyer, Newark, NJ (US)

(21) Appl. No.: 18/627,411

(22) Filed: Apr. 4, 2024

Related U.S. Application Data
(60) Provisional application No. 63/494,193, filed on Apr. 4, 2023.
(60) Provisional application No. 63/494,186, filed on Apr. 4, 2023.
(60) Provisional application No. 63/494,190, filed on Apr. 4, 2023.
(60) Provisional application No. 63/494,144, filed on Apr. 4, 2023.
(60) Provisional application No. 63/494,188, filed on Apr. 4, 2023.
(60) Provisional application No. 63/494,195, filed on Apr. 4, 2023.
(60) Provisional application No. 63/494,199, filed on Apr. 4, 2023.

(51) Int. Cl. G06F 21/10; G06Q 20/12; G06Q 20/38

(52) U.S. Cl. CPC G06F 21/1084; G06Q 20/123; G06Q 20/389

(57) ABSTRACT

In some embodiments, the present disclosure provides an exemplary method that may include steps of identifying a plurality of entities seeking to interact with each other; determining a set of artifacts associated with each entity of the plurality of entities; Utilizing a cloud-based functionality to dynamically connect at least two entities based on a determination of the set of artifacts shared between the at least two entities; dynamically integrating a plurality of protocols into an interaction session associated with the at least two entities; verifying the plurality of protocols associated with the interaction session; initiating the interaction session between at least two entities based on the plurality of protocols and the set of artifacts; and automatically modifying the interaction session to orchestrate a transfer of at least one artifact of the set of artifacts between the at least two entities.

### RELATED APPLICATIONS

This application claims the benefit of U.S. Application No. 63/494,186 entitled Computer-based Systems Configured to Automatically Update a Security Engine with a Plurality of Notifications and Methods of Use Thereof and filed on Apr. 4, 2023; U.S. Application No. 63/494,188 entitled Computer-based Systems Configured to Dynamically Retrieve a Plurality of Data Points from Disparate Data Sources and Methods of Use Thereof and filed on Apr. 4, 2023; U.S. Application No. 63/494,193 entitled Computer-based Systems Configured to Simultaneously Connect Multiple Parties and Methods of Use Thereof and filed on Apr. 4, 2023; U.S. Application No. 63/494,190 entitled Computer-based Systems Configured to Generate a Plurality of Navigation Tools for a Plurality of Users and Methods of Use Thereof and filed on Apr. 4, 2023; U.S. Application No. 63/494,144 entitled Computer-based Systems Configured to Dynamically Modify Input Data in Real-Time Based on a Baseline and Methods of Use Thereof and filed on Apr. 4, 2023; U.S. Application No. 63/494,195 entitled Computer-based Systems Configured to Automatically Connect a Plurality of Data Frameworks Simultaneously and Methods of Use Thereof and filed on Apr. 4, 2023; U.S. Application No. 63/494,199 entitled Computer-based Systems Configured to Modify Data to Perform at Least One Function and Methods of Use Thereof and filed on Apr. 4, 2023, which is hereby incorporated by reference in its entirety.

### FIELD OF TECHNOLOGY

The present disclosure generally relates to computer-based systems configured to orchestrate a transfer of a digital artifact and methods of use thereof.

### BACKGROUND OF TECHNOLOGY

Typically, a data transfer is the process of using computing techniques and technologies to transmit or transfer electronic or analog data from one computer node to another. Data is transferred in the form of bits and bytes over a digital or analog medium, and the process enables digital or analog communications and its movement between devices. A digital artifact is usually an undesired or unintended alteration in data introduced in a digital process by an involved technique and/or technology.

### SUMMARY OF DESCRIBED SUBJECT MATTER

In some embodiments, the present disclosure provides an exemplary technically improved computer-based method that includes at least the following steps: identifying a plurality of entities seeking to interact with each other; determining a set of artifacts associated with each entity of the plurality of entities; utilizing a cloud-based functionality to dynamically connect at least two entities based on a determination of artifacts shared between the at least two entities; dynamically integrating, in response to connecting the at least two entities, a plurality of protocols into an interaction session associated with the at least two entities, where the plurality of protocols associated with the interaction session include requirements to connect received from each entity of the plurality of entities; verifying the plurality of protocols associated with the interaction session, where verifying the plurality of protocols comprising ensuring a number of shared requirements from the plurality of entities exceed a predetermined threshold; initiating the interaction session between at least two entities based on the plurality of protocols and the set of artifacts; and automatically modifying the interaction session to orchestrate a transfer of at least one artifact of the set of artifacts between the at least two entities.

In some embodiments, a non-transitory computer-readable storage medium tangibly encoded with computer-executable instructions, that when executed by a device, perform a method including: identify a plurality of entities seeking to interact with each other; determine a set of artifacts associated with each entity of the plurality of entities; utilizing a cloud-based functionality to dynamically connect at least two entities based on a determination of artifacts shared between the at least two entities; dynamically integrate, in response to connecting the at least two entities, a plurality of protocols into an interaction session associated with the at least two entities, where the plurality of protocols associated with the interaction session include requirements to connect received from each entity of the plurality of entities; verify the plurality of protocols associated with the interaction session, where a verification the plurality of protocols includes ensuring a number of shared requirements from the plurality of entities exceed a predetermined threshold; an initiation the interaction session between at least two entities based on the plurality of protocols and the set of artifacts; and automatically modify the interaction session to orchestrate a transfer of at least one artifact of the set of artifacts between the at least two entities.

### BRIEF DESCRIPTION OF DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 depicts a block diagram of an exemplary computer-based system and platform for automatically modifying the interaction session to orchestrate a transfer of at least one artifact of the set of artifacts between the at least two entities, in accordance with one or more embodiments of the present disclosure.

FIG. 2 is a flowchart illustrating operational steps for automatically modifying the interaction session to orchestrate a transfer of at least one artifact of the set of artifacts between the at least two entities, in accordance with one or more embodiments of the present disclosure.

FIG. 3A and FIG. 3B depict a schematic of an upstream and downstream approach of an enterprise integration services layer module EISL between at least two entities, in accordance with one or more embodiments of the present disclosure.

FIG. 4 is a flowchart illustrating operational steps for a regulatory transaction control module reporting via reporting enhancements and communicating with a trade validation module.

FIG. 5 depicts a block diagram of exemplary computer-based system/platform in accordance with one or more embodiments of the present disclosure.

FIG. 6 depicts a block diagram of another exemplary computer-based system/platform in accordance with one or more embodiments of the present disclosure.

FIGS. 7 and 8 are diagrams illustrating implementations of cloud computing architecture/aspects with respect to which the disclosed technology may be specifically configured to operate, in accordance with one or more embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a creator interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, daily, several days, weekly, monthly, etc.

As used herein, the term “runtime” corresponds to any behavior that is dynamically determined during an execution of a software application or at least a portion of software application.

At least some embodiments of the present disclosure provide technological solution(s) to at least one technological computer-centered problem associated with orchestrating a transfer of a digital artifact between at least two entities wanting to trade between each other. An illustrative technological computer-centered problem associated with verifying identities of each entity that would like to interact and verifying a plurality of protocols associated with the transfer of a digital artifact are typical in this field. The problem further arises based on one or more entities seeking anonymity while interacting with other entities, as this may decrease a level of trust an opposing entity may have and/or give rise to fraudulent activities. Moreover, the more complex the digital artifact subject to transfer, the more complex the plurality of protocols associated with its transfer, further decreasing an optimal efficiency of the interaction. As detailed in at least some embodiments herein, at least one technological computer-centered solution associated with the illustrative technological computer-centered problem may include automatically modifying an interaction session to orchestrate a transfer of a particular artifact between at least two entities. In some embodiments, the present disclosure may identify a plurality of entities seeking to interact with each other. In some embodiments, the present disclosure may determine a set of artifacts associated with each entity of the plurality of entities. In certain embodiments, the set of artifacts may refer to a collection of digital artifacts capable of being transferred via a cloud-based network. In some embodiments, the present disclosure may utilize a cloud-based functionality to dynamically connect at least two entities based on a determination of artifacts shared between the at least two entities. In some embodiments, the present disclosure may dynamically integrate a plurality of protocols into an interaction session associated with the entities. In certain embodiments, the plurality of protocols may refer to a database of prestored rules and/or requirements that enable a secure interaction session between each entity. In some embodiments, the present disclosure may verify the plurality of protocols associated with the interaction session. In certain embodiments, a verification of the plurality of protocols ensures that a certain number of protocols are shared between the entities meets a predetermined threshold. In some embodiments, the present disclosure may initiate the interaction session between the entities based on the plurality of protocols meeting the predetermined threshold and the set of artifacts. In some embodiments, the present disclosure may automatically modify the interactions session. The modification may refer to an orchestration of a transfer of at least one artifact between the entities.

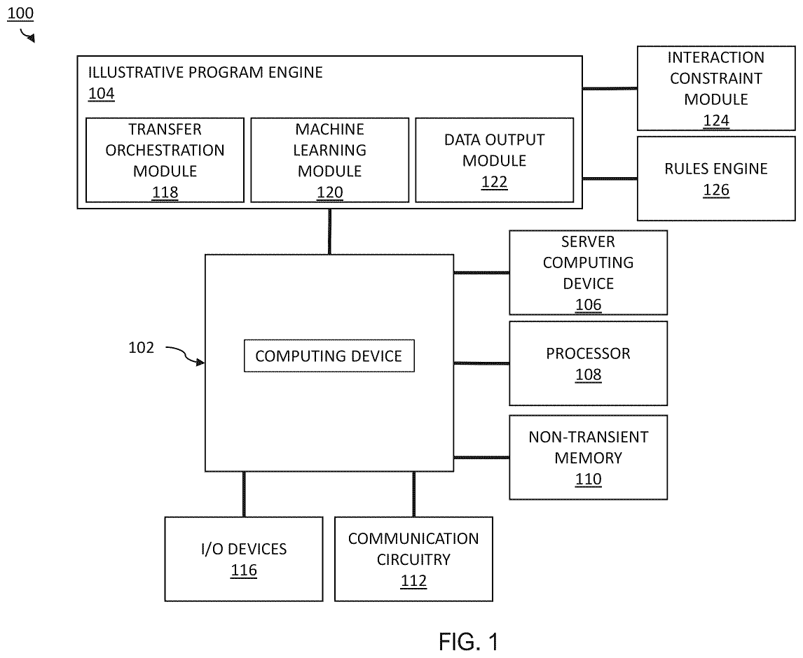

FIG. 1 depicts a block diagram of an exemplary computer-based system and platform for automatically modifying the interaction session to orchestrate a transfer of at least one artifact of the set of artifacts between the at least two entities, in accordance with one or more embodiments of the present disclosure.

In some embodiments, an illustrative computing system 100 of the present disclosure may include a computing device 102 associated with at least one user and an illustrative program engine 104. In some embodiments, the illustrative program engine 104 may be stored on the computing device 102. In some embodiments, the illustrative program engine 104 may be stored on the computing device 102, which may include a processor 108, a non-transitory memory 110, a communication circuitry 112 for communicating over a communication network 114 (not shown), and input and/or output (I/O) devices 116 such as a keyboard, mouse, a touchscreen, and/or a display, for example. In some embodiments, the computing device 102 may refer to at least one communication-enabled computing device of a plurality of communication-enabled computing devices.

In some embodiments, the illustrative program engine 104 may be configured to instruct the processor 108 to execute one or more software modules such as, without limitation, an exemplary transfer orchestration module 118, a machine learning module 120, and/or a data output module 122.

In some embodiments, the exemplary transfer orchestration module 118 of the present disclosure, may utilize at least one machine learning algorithm, described herein, to identify a plurality of entities seeking to interact with each other. In certain embodiments, the plurality of entities may refer to at least one of, but not limited to, the following: at least one individual, an enterprise, an integration service layer, a financial institution, a computing device 102 and/or a combination of both. In certain embodiments, the interaction may refer to a transaction and/or an initiation to a communication session between at least two entities. In some embodiments, the exemplary transfer orchestration module 118 may identify each entity of the plurality of entities as prospects, clients, parties, spouses, children, other relatives, attorneys, accountants, interested parties, corporations, partnerships, other legal entities, partners, officers, employers, charities, entities representing sets of accounts, and any other relevant legal entity, and single entities with multiple entity records and tailor subsequent interactions with each other based on the identification of each entity.

In some embodiments, the exemplary transfer orchestration module 118 may determine a set of artifacts associated with each entity. In certain embodiments, the artifact may refer to a transferrable object capable of providing an entity with data. In some embodiments, the exemplary transfer orchestration module 118 may dynamically connect the entities based on a determination of artifacts shared by the entities. In certain embodiments, the exemplary transfer orchestration module 118 utilize a cloud-based functionality to perform the connection of the entities. The cloud-based functionality may refer to a digital network capable of facilitating a digital interaction between a plurality of computing devices. In some embodiments, the exemplary transfer orchestration module 118 may dynamically connect the entities utilizing a interaction constraint module 124 to determine the shared artifacts between the two entities.

In some embodiments, the exemplary transfer orchestration module 118 dynamically integrate a plurality of protocols into an interaction session for the entities. In certain embodiments and in response to dynamically connecting the entities, the exemplary transfer orchestration module 118 may integrate the plurality of protocols into the interaction session. In certain embodiments, the plurality of protocols may refer to a plurality of requirements that provide a level of security to the interaction session.

In some embodiments, the exemplary transfer orchestration module 118 may verify the plurality of protocols associated with the interaction session. In some embodiments, the exemplary transfer orchestration module 118 may initiate the interaction session between the entities based on the verification of the plurality of protocols. In some embodiments, the exemplary transfer orchestration module 118 may automatically modify the interaction session to orchestrate a transfer of at least one artifact between the entities. In some embodiments, the illustrative program may identify a plurality of trades using a trade processing reporting tool. In some embodiments, the exemplary transfer orchestration module 118 may utilize a rules engine 126 to identify data breaks in the plurality of trades to compare the identified plurality of trades with a plurality of requests. In certain embodiments, the data breaks may refer to a time of non-action associated with each artifact. In some embodiments, the exemplary transfer orchestration module 118 may verify the security of the plurality of protocols by dynamically calculating a value associated with the identified artifact and aggregating an average value associated with the identified artifact and at least one request.

In some embodiments, the exemplary transfer orchestration module 118 may utilize a interaction constraint module 124 to streamline reporting via reporting enhancements via automated controls and system controls and communicates with a trade validation module 128 (not shown) to identify any trade rejects or exceptions for analysis and review. In certain embodiments, the regulatory control module 124 may generate a plurality of systematic reports to ensure that artifact transfers and requests for artifact transfers are automatically verified within the predetermined period of time.

In some embodiments, the exemplary transfer orchestration module 118 may systemically capture at least one predicted transfer of a particular artifact that fails to match the verified plurality of protocols. In some embodiments, the exemplary transfer orchestration module 118 may generate a control report based on received artifact data based on a predictive margin calculation. In certain embodiments, the predictive margin calculation may refer to a prediction of the difference between the value of the identified artifact and a value associated with the request for the received artifact. In some embodiments, the exemplary transfer orchestration module 118 may automatically and systemically track an age associated with the plurality of requests for artifact transfers and reports the age associated with each request for each artifact transfer in a control report. In some embodiments, the illustrative program 104 may generate system notices within the computing device 102 to determine that requests are submitted within the predetermined period of time. In certain embodiments, the illustrative program 104 may utilize the operations console device to generate one or more system notices within the computing device 102 to determine that requests are submitted within the predetermined period of time. In certain embodiments, the system notices may refer to a collection of control reports associated with the plurality of requests for artifact transfers with time stamps, where the collection may be converted into a log of notices that can be referred to for subsequent comparison of time for each artifact request.

In some embodiments, the exemplary transfer orchestration module 118 may utilize an enterprise integration services layer (hereinafter “EISL”) module to simultaneously connect multiple parties using a cloud functionality, a plurality of abstraction layers and a plurality of transformation layers. In certain embodiments, the exemplary transfer orchestration module 118 may utilize the EISL to communicate with a single gateway, an API management module, a notification hub, a data translation layer, and at least one backbridge layer. In some embodiments, the EISL module may provide connectivity, messaging, technical services, data services, and data transformation enabling an entire digital data management platform to operate the interaction session.

In some embodiments, the exemplary transfer orchestration module 118 may support distributed and legacy mainframe applications, where each application has a predetermined set of protocols required to establish a secure connection. In some embodiments, the exemplary transfer orchestration module 118 may utilize the enterprise integration services layer module to access multiple data services associated with each entity in an orchestrated way. In some embodiments, the enterprise integration services layer module may predict whether each entity can meet requirements without changing formats or protocols for downstream/upstream applications. In certain embodiment, the enterprise integration services layer module's ability to predict the requirement threshold between entities may reduce cost and time to execute the transfer of the artifact. In some embodiments, the enterprise integration services layer module may provide an access to the entities to a plurality of services, such as mediation services and orchestration services in a unified manner.

In some embodiments, a single data gateway tool associated with the exemplary transfer orchestration module 118 may provide a single definition of data across a plurality of systems and may serve as a gateway to access multiple data services in an orchestrated way. For example, the single data gateway tool may normalize the data associated with the artifact subject to the transfer between the entities. In some embodiments, the exemplary transfer orchestration module 118 may utilize an API management module to leverage API capabilities to address security, monitor and manage traffic within the interaction session; and provide analytics to ensure consistency between multiple API implementations and versions. In some embodiments, the notification hub associated with the exemplary transfer orchestration module 118 may identify any associated data types and locations for the artifact transfer including discrete artifacts associated with exceptions resulting from a plurality of data interactions. For example, the notification hub may be a tool associated with the data workstation. In some embodiments, the exemplary transfer orchestration module 118 may provide a plurality of continuous notifications that inform at least one entity of a plurality of entities of the modifications to critical data and the interaction session via a message-streaming component. In some embodiments, the exemplary transfer orchestration module 118 may utilize a data translation layer to digitally trace messages and implement a plurality of data controls associated with the interaction session. In some embodiments, the exemplary transfer orchestration module 118 may utilize the backbridge layer to limit the development and testing required for subsequent modification to the interaction session by providing like-for-like datasets and services as currently received.

In some embodiments, the exemplary transfer orchestration module 118 may utilize a unified management account module to include a plurality of types of data displayed via a plurality of data structure sleeves associated with a plurality of data schemas. In certain embodiments, the plurality of data structure sleeves may refer to a plurality of artifacts, such as data representing investment vehicles, associated with at least one account of a plurality of accounts. In certain embodiments, each account may be associated with a particular entity. In some embodiments, each data structure sleeve of the plurality of data structure sleeves may represent a particular data sleeve within a particular account. In some embodiments, the plurality of data structure sleeves may be displayed through a user interface located on the data workstation. In certain embodiments, the plurality of data structure sleeves may include any or all of the following: managed investment strategies, mutual funds, and/or electric transaction funds capable of being transferred within the interaction session. In some embodiments, the plurality of data structure sleeves may provide the ability to partition positions and simulate a plurality of strategies within plurality of data schemas of the particular portfolio associated with each entity. In some embodiments, at least one data strategy manager may have a dedicated data structure sleeve within the plurality of data structure sleeves associated with the particular account. In some embodiments, the plurality of investment vehicles within the particular portfolio may be stored in an external database and/or server computing device 106. In some embodiments, the plurality of data structure sleeves are not user accounts. In some embodiments, the plurality of data structure sleeves may have the same characteristics as the particular account that the plurality of investment vehicles can transfer within a secure interaction session.

In some embodiments, the exemplary transfer orchestration module 118 may utilize a data workstation framework that has a front-end framework that gives structure and control for system, pages, and components level customization to provide the entities an ability to navigate to the interaction session from a menu. In some embodiments, the data workstation framework may require a digital single sign-on (hereinafter “SSO”) entry. In some embodiments, the data workstation framework may utilize a screen container with a plurality of programmable graphical user interface (“GUI”) elements to display a plurality of windows on a user dashboard upon launch. In some embodiments, the data workstation framework may display a masthead menu structure based on a plurality of user entitlements. In some embodiments, the data workstation framework may run a plurality of data windows simultaneously. In some embodiments, the data workstation framework may provide an entity additional controls within the interaction session, such as automatically transmitting signals in response to receiving a signal from an entity related to a subsequent action. For example, the entity may initiate the transfer of the artifact via the data workstation framework. In some embodiments, the data workstation framework may display market data in a snap quote box within at least one window of the user dashboard. In some embodiments, the data workstation framework may dynamically print via a browser print function and the plurality of individual applications may retain each applications own print functions where applicable.

In some embodiments, a plurality of login authorization and/or entitlements associated with the data workstation framework may connect into an external data source to establish the interaction session. In some embodiments, a theme management module may control styling and branding, which may be centrally managed by the data workstation framework and allows for consistent updating throughout a data ecosystem. In some embodiments, a plurality of navigations may be configurable, componentized, and entitlement based. In certain embodiments, the data workstation framework may generate the plurality of navigations to the entity to hide at least one page by adjusting a configuration in the data workstation framework. In some embodiments, a context passing module may include a screen that accepts and passes through relevant context. In some embodiments, the data workstation framework may utilize the context passing module to transmit entity information in context for each relevant screen with the data workstation framework. In some embodiments, the input interface layer may be controlled by the data workstation framework and may be configurable through an administration tool. In some embodiments, the data workstation framework may utilize a plurality of applications rendered by the input interface layer. In some embodiments, the data workstation framework may provide a responsive design rendered on multiple devices, such as a screen size of 1280-1920 pixels.

In some embodiments, the exemplary transfer orchestration module 118 may utilize tracking layer to track and record a plurality of details associated with a plurality of artifact transfers within any interaction session. The exemplary transfer orchestration module 118 may calculate a trade margin for each trade to manage the margins of each artifact transfer and ensure the margins are within predetermined levels. In some embodiments, the exemplary transfer orchestration module 118 may utilize a security module associated with the to integrate with other security modules to provide real-time or near real-time automated security set up and support for vendor data sources. In some embodiments, the security module may consolidate security information associated with the particular artifact and the particular entity within the interaction session. In some embodiments, the exemplary transfer orchestration module 118 may feed security data to the server computing device 106.

In some embodiments, the exemplary transfer orchestration module 118 may utilize a consolidated blotting engine to provide a solution to a plurality of scenarios associated with the prediction of artifact transfer between the entities in the interaction session. In some embodiments, the exemplary transfer orchestration module 118 may automatically update the security data based on the output of the consolidated blotting engine associated with the particular artifact transfer notifications and a direct feed into an operational system of the external computing device. In certain embodiments, the exemplary transfer orchestration module 118 may utilize the consolidated blotting engine to provide confirmation of available artifacts and completed artifact transfers within the interaction session. In some embodiments, the exemplary transfer orchestration module 118 may provide a streamlined root cause analysis of a reconciliation failure associated with an attempted artifact transfer within the interaction session. In some embodiments, the consolidated blotting engine may systemically generate reconciliations; mitigate operations risk or errors through automation; provide real-time status of transfers; and provide an automated order routing and/or booking for downstream processing.

In some embodiments, an illustrative program 104 may identify at least one artifact transfer request. In some embodiments, the illustrative program 104 may input the identified artifact transfer request into a plurality of verified interaction sessions that meet at least one predetermined criterion associated with the artifact. In some embodiments, the illustrative program 104 may consolidate at least two results of a predicted artifact transfer into a blotting engine. In some embodiments, the illustrative program 104 may allocate the consolidated results associated with the identified artifact transfer request to corresponding server computing devices 106 associated with the particular entity based on an artifact settlement requirement. In some embodiments, the illustrative program 104 may perform a plurality of additional calculations, where the additional calculations mitigate operations risk and/or errors via automation for the artifact transfer within the interaction session. In some embodiments, the illustrative program 104 may utilize a settlement engine to transmit artifact transfer information to the other entity within the interaction session and generate a confirmation notification associated with the artifact transfer.

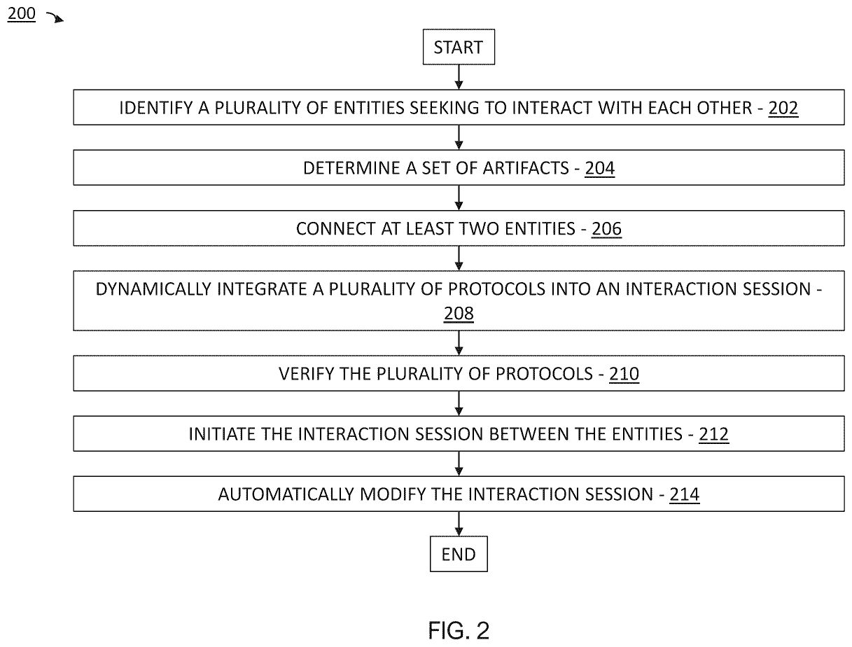

FIG. 2 is a flowchart 200 illustrating operational steps for automatically modifying the interaction session to orchestrate a transfer of at least one artifact of the set of artifacts between the at least two entities, in accordance with one or more embodiments of the present disclosure.

In step 202, the illustrative program engine 104 of the computing device 102 identifies a plurality of entities seeking to interact with each other. In some embodiments, the illustrative program engine 104 may identify the plurality of entities seeking to interact with each other. In certain embodiments, each entity of the plurality of entities may refer to at least one of, but not limited to, an individual, a computing device 102 associated with the individual, a financial institution, and/or a server computing device 106 associated with a company. In some embodiments, the exemplary transfer orchestration module 118 may identify the plurality of entities seeking to interact with each other.

In step 204, the illustrative program engine 104 determines a set of artifacts. In some embodiments, the illustrative program engine 104 may determine at least one artifact of the set of artifacts capable of being digitally transferred between computing devices 102. In some embodiments, each artifact may be associated with a particular entity. In some embodiments, the exemplary transfer orchestration module 118 may determine the set of artifacts associated with each entity.

In step 206, the illustrative program engine 104 connects at least two entities. In some embodiments, the illustrative program engine 104 may utilize a cloud-based functionality to dynamically connect the entities. In some embodiments, the illustrative program engine 104 may dynamically connect the entities based on a determination of artifacts. The determination of the artifacts may refer to a number of shared artifacts between the entities attempting to connect. In some embodiments, the exemplary transfer orchestration module 118 may utilize the cloud-based functionality to dynamically connect the entities based on the determination of artifacts.

In step 208, the illustrative program engine 104 dynamically integrates a plurality of protocols into an interaction session. In some embodiments, the illustrative program engine 104 may dynamically integrate the plurality of protocols in response to connecting the entities. In some embodiments, the illustrative program engine 104 may dynamically integrate the plurality of protocols into the interaction session associated with the entities. In certain embodiments, the plurality of protocols may refer to a plurality of requirements that must be completed to initiate a secure interaction session. In some embodiments, the exemplary transfer orchestration module 118 may dynamically integrate the plurality of protocols into the interaction session associated with the entities.

In step 210, the illustrative program engine 104 verify the plurality of protocols. In some embodiments, the illustrative program engine 104 may verify the plurality of protocols associated with the interaction session. In some embodiments, the illustrative program engine 104 may verify the plurality of protocols associated with the interaction session by utilizing the interaction constraint module 124 to secure the interaction session. In certain embodiments, the verification of the plurality of protocols may require a number of shared requirements between entities meeting and/or exceeding a predetermined threshold. In some embodiments, the exemplary transfer orchestration module 118 may verify the plurality of protocols associated with the interaction session.

In step 212, the illustrative program engine 104 initiate the interaction session between the entities. In some embodiments, the illustrative program engine 104 may initiate the interaction session between the entities based on the plurality of protocols. In some embodiments, the illustrative program engine 104 may initiate the interaction session between the entities based on the set of artifacts subject to transfer. In some embodiments, the illustrative program engine 104 may initiate the interaction session between the entities based on a combination of the plurality of protocols and the set of artifacts subject to transfer. In some embodiments, the exemplary transfer orchestration module 118 may initiate the interaction session between the entities based on a combination of the plurality of protocols and the set of artifacts subject to transfer.

In step 214, the illustrative program engine 104 automatically modify the interaction session. In some embodiments, the illustrative program engine 104 may automatically modify the interaction session to orchestrate a transfer of an artifact. In some embodiments, the illustrative program engine 104 may orchestrate the transfer of an artifact of the set of artifacts between the entities. In some embodiments, the transfer of the artifact may be a dynamic result of the verified interaction session that was initiate to transfer the artifact between the entities. In some embodiments, the exemplary transfer orchestration module 118 may automatically modify the interaction session to orchestrate a transfer of an artifact.

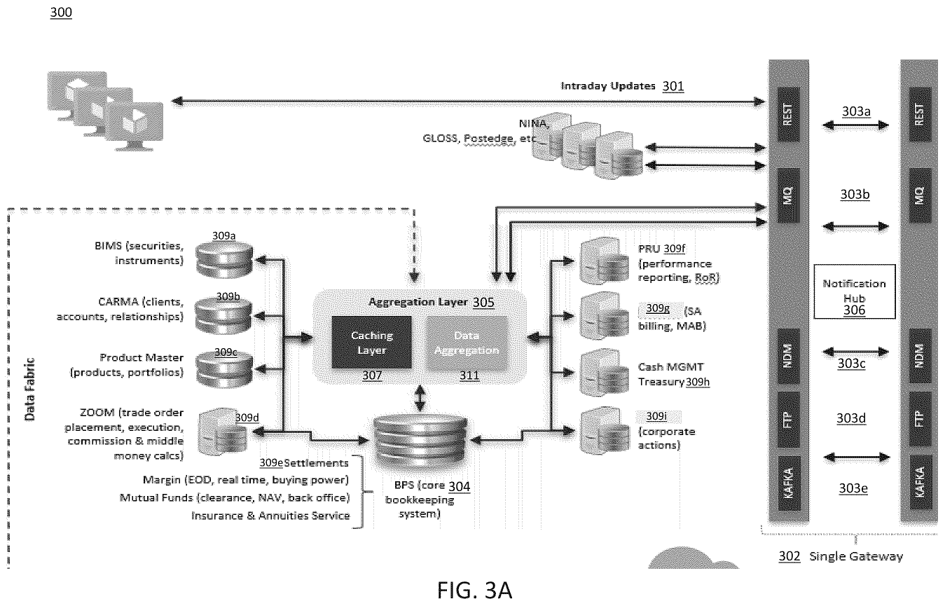

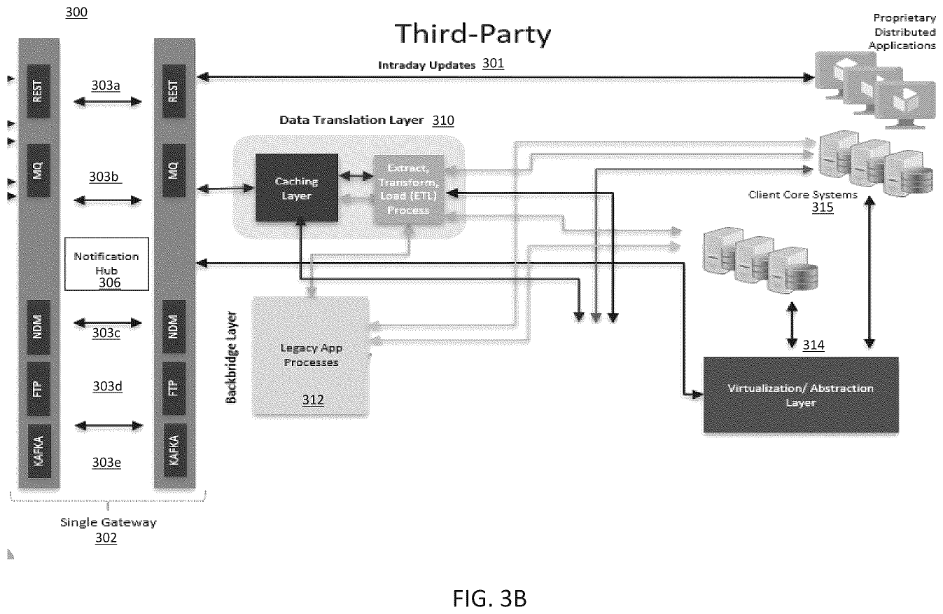

FIG. 3A and FIG. 3B depict a schematic showing the EISL module 300 orchestrate an artifact transfer between at least two entities. In some embodiments, the EISL 300 may receive a plurality of requirements from an entity willing to participate in a secure interaction session, where the plurality of requirements may refer to a plurality of intraday updates 301. The EISL 300 may verify the plurality of requirements to ensure there are not substantially duplicates of prior and/or existing requirements within the plurality of requirements. In some embodiments, the EISL 300 may transmit a plurality of updated requests for existing service. In some embodiments, the EISL 300 may collate the logic for any derived attributes as needed to build a plurality of derivations and provide the attributes needed for the plurality of derivations as part of the requirement. In some embodiments, the EISL 300 may review a plurality of artifacts. In some embodiments, the EISL 300 may complete any additional mapping that can be achieved. In some embodiments, the EISL 300 may publish a plurality of questions and/or data gaps to the plurality of downstream users.

In some embodiments, the enterprise integration services layer module 300 may integrate with internal and external applications in the current landscape and a future landscape. In some embodiments, the enterprise integration services layer module 300 may support distributed and legacy mainframe applications. In some embodiments, the enterprise integration services layer module 300 may access multiple data services in an orchestrated way. In some embodiments, the enterprise integration services layer module 300 may meet requirements without changing formats or protocols for verified interaction sessions.

In some embodiments, a single data gateway tool 302 may provide a single definition of data across a plurality of systems and may serve as a gateway to access multiple data services 303 in an orchestrated way. In certain embodiments, the multiple data services 303 may include, but not limited to, resting time service 303a, message quality 303b, network data mover 303c, file transfer protocol 303d, and kafka service 303e, where the kafka service 303e may refer to a service capable of building real-time data pipelines and applications that adapt to data streams. In some embodiments, an API management module 304 via an aggregation layer 305 may leverage API capabilities to address security, monitor and manage traffic, provide analytics and ensure consistency between multiple API implementations and versions. In certain embodiments, the aggregation layer 305 may utilize the API management module 304 to address security via a caching layer 307, where the caching layer 307 communicates with a security instrument layer 309a, a client, account, and relationship layer 309b, a product master layer 309c, an artifact request layer 309d, a settlement layer 309e. In certain embodiments, the aggregation layer 305 may utilize the API management module 304 to provide analytics via a data aggregation layer 311, where the data aggregation layer 311 communicates with a performance layer 309f, a billing layer 309g, a cash treasury management layer 309h, and a corporate action layer 309i. In certain embodiments, the API management module 304 may refer to a core bookkeeping system associated with the EISL 300. In some embodiments, the notification hub 306 may identify all associated data types and locations for the event including discrete artifacts associated to exceptions resulting from a plurality of data interactions. In some embodiments, the enterprise integration services layer module 300 may provide a plurality of continuous notifications that inform at least one entity of a plurality of entities of changes to critical data via an artifact transfer message-streaming component 308. In some embodiments, a data translation layer 310 may digitally trace messages and implement a plurality of data controls. In certain embodiments, the data translation layer 310 may utilize the caching layer 307 and an extract transform load process layer 313 to digitally trace the messages and implement the data controls. In some embodiments, the backbridge layer 312 may limit the development and testing required for staying applications by providing like-for-like datasets and services as currently received. In some embodiments, the output of the notification hub 306 may flow into an abstraction layer 314 that may further communicate with a plurality of computing devices, where the plurality of computing devices may refer to a client core system 315.

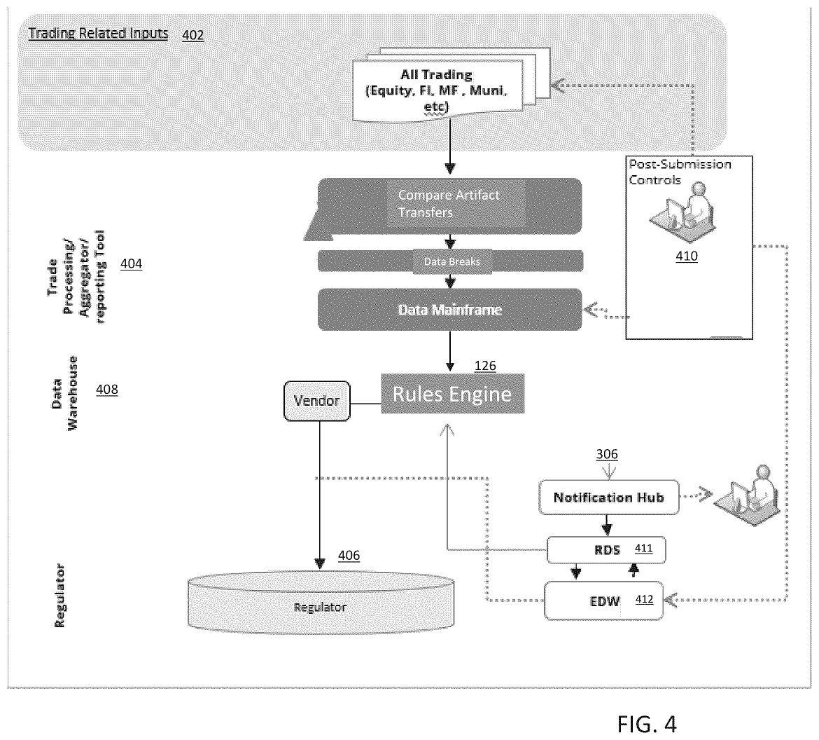

FIG. 4 depicts a flowchart 400 illustrating operational steps for a interaction constraint module 124 that streamlines reporting via reporting enhancements via automated controls and system controls and communicates with the exemplary transfer orchestration module 118. In some embodiments, a plurality of artifact transfers related inputs 402 feed into the interaction constraint module 124. In some embodiments, the interaction constraint module 400 may utilize the plurality of trading related inputs 402 to compare artifact transfers associated with the inputs and any transfers associated with an interaction session. In some embodiments, the interaction constraint module 124 may communicate with an allocation recon tool 404 that may be capable of comparing a plurality of requests to identify a plurality of data breaks. In some embodiments, the allocation recon tool 404 may communication with a rule engine 126. In some embodiments, the rule engine 126 may identify the plurality of data breaks of the plurality of artifact transfers to compare the identified plurality of transfers with a plurality of requests. In certain embodiments, any results of the rules engine 126 may be stored within the server computing device 106. In some embodiments, the interaction constraint module 124 may systemically capture any artifact transfer that fail to process between the allocation recon tool 404 and the rules engine 126. In some embodiments, the interaction constraint module 124 may automatically track an age associated with each request of the plurality of requests within a request repository 408. In certain embodiments, the request repository 408 may refer to a data warehouse. In some embodiments, the interaction constraint module 124 may generate a plurality of systemic notices to ensure the plurality of requests are submitted within a predetermined period of time. In certain embodiments, the predetermined period of time may refer to a 10-day requirement associated with the plurality of requests. In certain embodiments, a regulator 406 may verify the time stamps associated with each system notice generated by the interaction constraint module 124. In response to the verification via the regulator 406, the interaction constraint module 124 may transmit the plurality of verified notices to a user for subsequent post-submission controls 410 via the notification hub 306, where the notification hub 306 may communicate with a remote desktop service 411 and an enterprise data warehouse 412 before transmitting the verified notice to the user for post-submission controls 410. In certain embodiments, the post-submission controls 410 may modify the plurality of artifact request associated with the interaction constrain module 124.

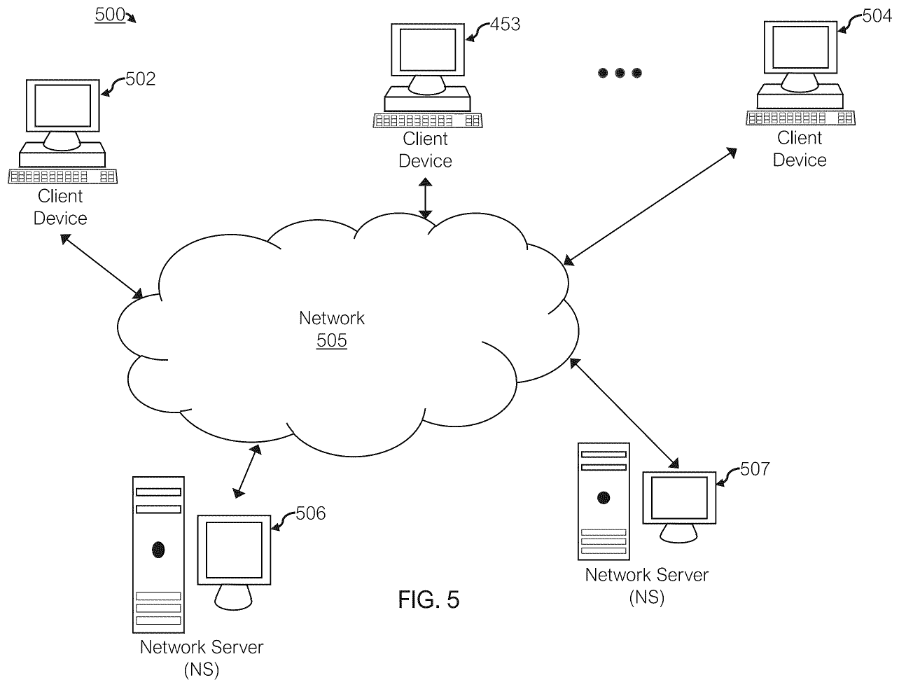

FIG. 5 depicts a block diagram of an exemplary computer-based system/platform 500 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the exemplary inventive computing devices and/or the exemplary inventive computing components of the exemplary computer-based system/platform 500 may be configured to automatically modifying the interaction session to orchestrate a transfer of at least one artifact of the set of artifacts between the at least two entities, as detailed herein.

In some embodiments, the exemplary computer-based system/platform 500 may be based on a scalable computer and/or network architecture that incorporates varies strategies for assessing the data, caching, searching, and/or database connection pooling. An example of the scalable architecture is an architecture that is capable of operating multiple servers. In some embodiments, the exemplary inventive computing devices and/or the exemplary inventive computing components of the exemplary computer-based system/platform 500 may be configured to remotely execute the instructions associated with the exemplary transfer orchestration module 118 of the present disclosure, automatically utilizing at least one machine-learning model described herein.

In some embodiments, referring to FIG. 5, members 502-504 (e.g., clients) of the exemplary computer-based system/platform 500 may include virtually any computing device capable of utilizing the exemplary transfer orchestration module 118 to automatically modify the interaction session to orchestrate a transfer of at least one artifact of the set of artifacts between the at least two entities via a network (e.g., cloud network 109), such as network 505, to and from another computing device, such as servers 506 and 507, each other, and the like. In some embodiments, the member devices 502-504 may be smart phones, personal computers, multiprocessor systems, microprocessor-based or programmable consumer electronics, network PCs, and the like. In some embodiments, one or more member devices within member devices 502-504 may include computing devices that connect using a wireless communications medium such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member devices 502-504 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member devices within member devices 502-504 may include may launch one or more applications, such as Internet browsers, mobile applications, voice calls, video games, videoconferencing, and email, among others. In some embodiments, one or more member devices within member devices 502-404 may be configured to receive and to send web pages, and the like. In some embodiments, the exemplary transfer orchestration module 118 of the present disclosure may be configured to collect market input to modify the converted uniform data state input data to match market output data based on the established baseline and employ virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 502-504 may be specifically programmed by either Java, .Net, QT, C, C++ and/or other suitable programming language. In some embodiments, one or more member devices within member devices 502-504 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 505 may provide network access, data transport and/or other services to any computing device coupled to it. In some embodiments, the exemplary network 505 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 405 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 505 may include and implement, as an alternative or in conjunction with one or more of the above, a WiMAX architecture defined by the WiMAX forum. In some embodiments and, optionally, in combination of any embodiment described above or below, the exemplary network 505 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 505 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 405 may also include mass storage, such as network attached storage (NAS), a storage area network (SAN), a content delivery network (CDN) or other forms of computer or machine-readable media.

In some embodiments, the exemplary server 506 or the exemplary server 507 may be a web server (or a series of servers) running a network operating system, examples of which may include but are not limited to Microsoft Windows Server, Novell NetWare, or Linux. In some embodiments, the exemplary server 506 or the exemplary server 507 may be used for and/or provide cloud and/or network computing. Although not shown in FIG. 5, in some embodiments, the exemplary server 506 or the exemplary server 507 may have connections to external systems like email, SMS messaging, text messaging, ad content providers, etc. Any of the features of the exemplary server 506 may be also implemented in the exemplary server 507 and vice versa.

In some embodiments, one or more of the exemplary servers 506 and 507 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 501-504.

In some embodiments and, optionally, in combination of any embodiment described above or below, for example, one or more exemplary computing member devices 502-504, the exemplary server 506, and/or the exemplary server 507 may include a specifically programmed software module that may be configured to automatically modify the interaction session to orchestrate a transfer of at least one artifact of the set of artifacts between the at least two entities.

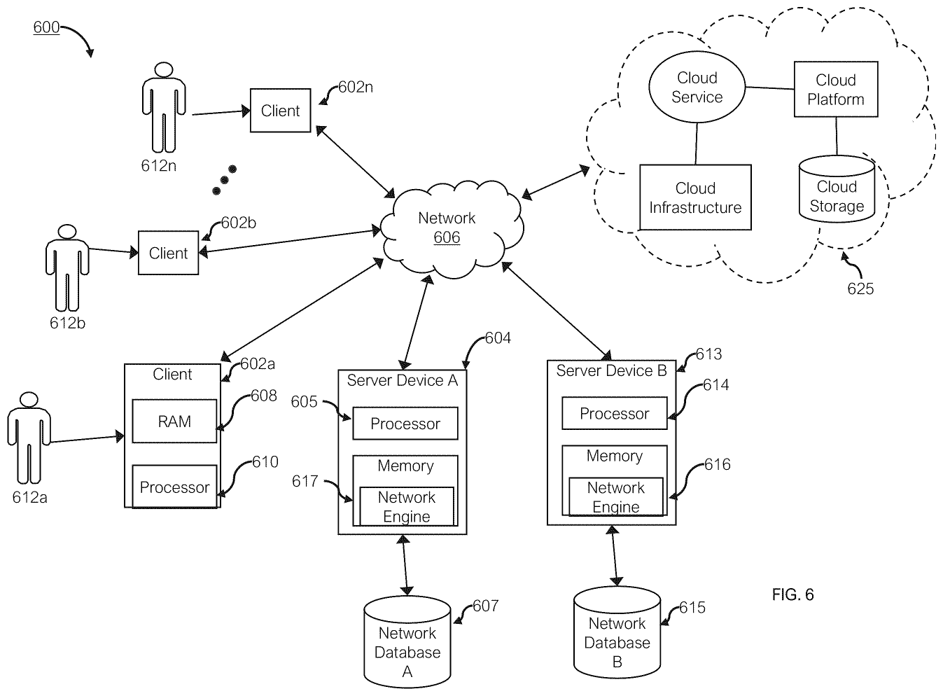

FIG. 6 depicts a block diagram of another exemplary computer-based system/platform 600 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing devices 602a, 602b thru 602n shown each at least includes a computer-readable medium, such as a random-access memory (RAM) 608 coupled to a processor 610 or FLASH memory. In some embodiments, the processor 610 may execute computer-executable program instructions stored in memory 608. In some embodiments, the processor 610 may include a microprocessor, an ASIC, and/or a state machine. In some embodiments, the processor 510 may include, or may be in communication with, media, for example computer-readable media, which stores instructions that, when executed by the processor 610, may cause the processor 610 to perform one or more steps described herein. In some embodiments, examples of computer-readable media may include, but are not limited to, an electronic, optical, magnetic, or other storage or transmission device capable of providing a processor, such as the processor 610 of client 602a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 602a through 602n may also comprise a number of external or internal devices such as a mouse, a CD-ROM, DVD, a physical or virtual keyboard, a display, a speaker, or other input or output devices. In some embodiments, examples of member computing devices 602a through 602n (e.g., clients) may be any type of processor-based platforms that are connected to a network 606 such as, without limitation, personal computers, digital assistants, personal digital assistants, smart phones, pagers, digital tablets, laptop computers, Internet appliances, and other processor-based devices. In some embodiments, member computing devices 602a through 602n may be specifically programmed with one or more application programs in accordance with one or more principles/methodologies detailed herein. In some embodiments, member computing devices 602a through 602n may operate on any operating system capable of supporting a browser or browser-enabled application, such as Microsoft™ Windows™, and/or Linux. In some embodiments, member computing devices 602a through 602n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 602a through 602n, users, 612a through 612n, may communicate over the exemplary network 606 with each other and/or with other systems and/or devices coupled to the network 606. As shown in FIG. 6, exemplary server devices 604 and 613 may be also coupled to the network 606. Exemplary server device 604 may include a processor 605 coupled to a memory that stores a network engine 617. Exemplary server device 613 may include a processor 614 coupled to a memory 616 that stores a network engine. In some embodiments, one or more member computing devices 602a through 602n may be mobile clients. As shown in FIG. 6, the network 606 may be coupled to a cloud computing/architecture(s) 625. The cloud computing/architecture(s) 625 may include a cloud service coupled to a cloud infrastructure and a cloud platform, where the cloud platform may be coupled to a cloud storage.

In some embodiments, at least one database of exemplary databases 607 and 615 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

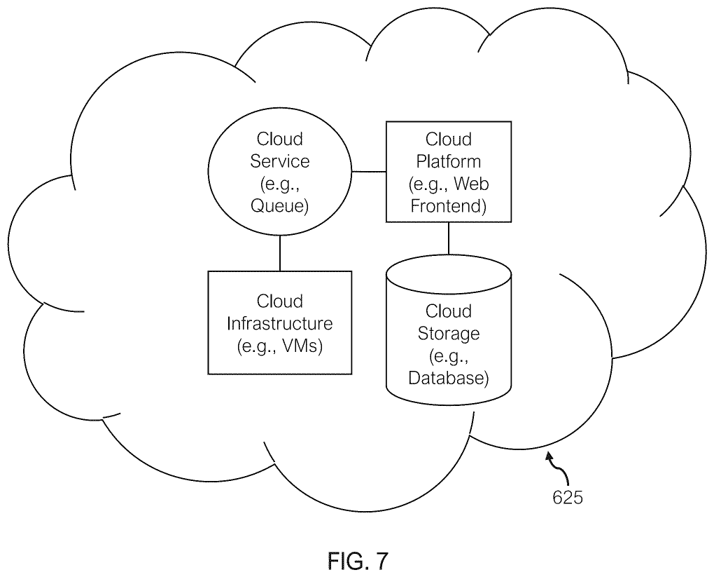

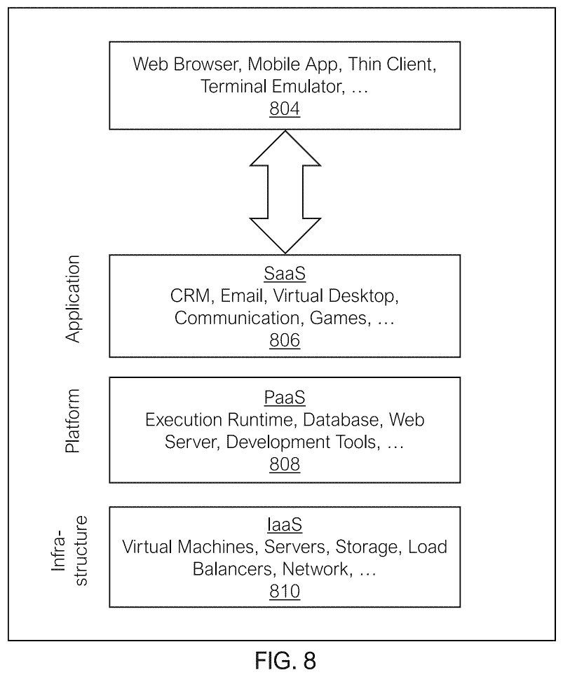

FIG. 7 and FIG. 8 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate. FIG. 7 illustrates an expanded view of the cloud computing/architecture(s) 625 found in FIG. 6. FIG. 8. illustrates the exemplary inventive computer-based components of the present disclosure may be specifically configured to operate in the cloud computing/architecture 625 as a source database 804, where the source database 804 may be a web browser. a mobile application, a thin client, and a terminal emulator. In FIG. 8, the exemplary inventive computer-based systems/platforms, the exemplary inventive computer-based devices, and/or the exemplary inventive computer-based components of the present disclosure may be specifically configured to operate in a cloud computing/architecture such as, but not limiting to: infrastructure a service (IaaS) 810, platform as a service (PaaS) 808, and/or software as a service (SaaS) 806.

In some embodiments and, optionally, in combination of any embodiment described above or below, the exemplary trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the exemplary aggregation function may be a mathematical function that combines (e.g., sum, product, etc.) input signals to the node. In some embodiments and, optionally, in combination of any embodiment described above or below, an output of the exemplary aggregation function may be used as input to the exemplary activation function. In some embodiments and, optionally, in combination of any embodiment described above or below, the bias may be a constant value or function that may be used by the aggregation function and/or the activation function to make the node more or less likely to be activated.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; knowledge corpus; stored audio recordings; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. In some embodiments, the server may store transactions and dynamically trained machine learning models. Cloud servers are examples.

In some embodiments, as detailed herein, one or more of exemplary inventive computer-based systems/platforms, exemplary inventive computer-based devices, and/or exemplary inventive computer-based components of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a social media post, a map, an entire application (e.g., a calculator), etc. In some embodiments, as detailed herein, one or more of exemplary inventive computer-based systems/platforms, exemplary inventive computer-based devices, and/or exemplary inventive computer-based components of the present disclosure may be implemented across one or more of various computer platforms such as, but not limited to: (1) FreeBSD™, NetBSD™, OpenBSD™; (2) Linux™; (3) Microsoft Windows™; (4) OS X (MacOS)™; (5) MacOS 11™; (6) Solaris™; (7) Android™; (8) iOS™; (9) Embedded Linux™; (10) Tizen™; (11) WebOS™; (12) IBM i™; (13) IBM AIX™; (14) Binary Runtime Environment for Wireless (BREW)™; (15) Cocoa (API)™; (16) Cocoa Touch™; (17) Java Platforms™; (18) JavaFX™; (19) JavaFX Mobile;™ (20) Microsoft DirectX™; (21) .NET Framework™; (22) Silverlight™; (23) Open Web Platform™; (24) Oracle Database™; (25) Qt™; (26) Eclipse Rich Client Platform™; (27) SAP NetWeaver™; (28) Smartface™; and/or (29) Windows Runtime™.

In some embodiments, exemplary inventive computer-based systems/platforms, exemplary inventive computer-based devices, and/or exemplary inventive computer-based components of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device. In at least one embodiment, the exemplary spam prevention module 118 of the present disclosure, utilizing at least one machine-learning model described herein, may be referred to as exemplary software.

In some embodiments, exemplary inventive computer-based systems/platforms, exemplary inventive computer-based devices, and/or exemplary inventive computer-based components of the present disclosure may be configured to handle numerous concurrent tests for software agents that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, exemplary inventive computer-based systems/platforms, exemplary inventive computer-based devices, and/or exemplary inventive computer-based components of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, and/or objects. For example, such projections may be a visual overlay for a mobile augmented reality (MAR) application.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™ Pager, Smartphone, or any other reasonable mobile electronic device.

While one or more embodiments of the present disclosure have been described, it is understood that these embodiments are illustrative only, and not restrictive, and that many modifications may become apparent to those of ordinary skill in the art, including that various embodiments of the inventive methodologies, the inventive systems/platforms, and the inventive devices described herein can be utilized in any combination with each other. Further still, the various steps may be carried out in any desired order (and any desired steps may be added and/or any desired steps may be eliminated).

What is claimed is:

1. A computer-implemented method comprising:
identifying, by at least one processor, a plurality of entities seeking to interact with each other;
determining, by the at least one processor, a set of artifacts associated with each entity of the plurality of entities;
utilizing, by the at least one processor, a cloud-based functionality to dynamically connect at least two entities based on a determination of the set of artifacts shared between the at least two entities;
dynamically integrating, by the at least one processor and in response to connecting the at least two entities, a plurality of protocols into an interaction session associated with the at least two entities,
wherein the plurality of protocols associated with the interaction session comprise requirements to connect received from each entity of the plurality of entities;
verifying, by the at least one processor, the plurality of protocols associated with the interaction session,
wherein verifying the plurality of protocols comprising ensuring a number of shared requirements from the plurality of entities exceed a predetermined threshold;
initiating, by the at least one processor, the interaction session between at least two entities based on the plurality of protocols and the set of artifacts; and
automatically modifying, by the at least one processor, the interaction session to orchestrate a transfer of at least one artifact of the set of artifacts between the at least two entities.

2. The method of claim 1, wherein each entity is a server computing device associated with a financial institution.

3. The method of claim 1, wherein the artifact comprises a digitally transferable data item.

4. The method of claim 1, wherein the determination of the set of artifacts comprises utilizing the interaction constraint module to analyze any shared artifacts between the at least two entities.

5. The method of claim 1, wherein the cloud-based functionality comprises a digital network capable of facilitating a digital interaction between a plurality of computing devices.

6. The method of claim 1, wherein the dynamic integration of the plurality of protocols comprises utilizing a rules engine to identify data breaks in the set of artifacts for subsequent comparison with a plurality of artifact requests.

7. The method of claim 1, wherein the interaction session comprises a secure digital marketplace that allows an entity to exchange the artifact for a data.

8. The method of claim 1, wherein the automatic modifying of the interaction session comprises reducing one or more authentication steps required to orchestrate the transfer of the artifact between the at least two entities.

9. The method of claim 1, further comprising utilizing an enterprise integration services layer module to predict a likelihood associated with a successful transfer of a particular artifact between the at least two entities.

10. The method of claim 9, wherein the enterprise integration services layer comprises:
a single gateway module;
an API management module;
a data workstation framework;
a data translation layer; and
at least one backbridge layer.

11. The method of claim 9, wherein the enterprise integration services layer predicts the likelihood of a successful transfer comprises dynamically predicting that each entity can meet requirements without modifying the plurality of protocols for subsequent artifact transfers.

12. The method of claim 11, wherein the dynamically predicting that each entity can meet the requirements without modification comprises utilizing a rules engine to collate any transfer information for any derived attributes associated with a particular artifact and a particular entity to build a plurality of derivations and provide the attributes needed for the plurality of derivations as part of the requirement associated with the plurality of protocols.

13. The method of claim 1, further comprising:
systemically capturing at least one predicted artifact transfer of a particular artifact that fails to match the verified plurality of protocols; and
generating a plurality of systematic reports associated with a plurality of predicted artifact transfers and requests for artifact transfers that are automatically verified within the predetermined period of time.

14. The method of claim 1, further comprising:
utilizing at least one machine learning module to analyze a particular data sleeve associated with each entity, wherein the particular data sleeve contains protocol preferences and predetermined artifact transfer rules.

15. The method of claim 1, further comprising:
utilizing the interaction constraint module to receive plurality of artifact transfers related inputs;
utilizing an allocation recon tool to comparing the plurality of artifact transfers to a plurality of transfer related inputs to determine additional inputs and common artifacts transfers associated with the interaction session;
utilizing a machine learning module to identify a plurality of data breaks associated with a comparison of the plurality of artifact transfers to the plurality of transfer related inputs;
automatically tracing an age associated with each request of the plurality of artifact transfers within an external database; and
generating a plurality of systemic notices to ensure the plurality of artifact transfers are submitted within a predetermined period of time.

16. The method of claim 1, further comprising utilizing the interaction constraint module to initiate a secure interaction session between the at least two entities.

17. The method of claim 1, further comprising utilizing a data workstation framework to display a notification associated with the artifact transfer within the interaction session.

18. A computer-implemented method comprising:
identifying, by at least one processor, a plurality of entities seeking to interact with each other;
determining, by the at least one processor, a set of artifacts associated with each entity of the plurality of entities;
utilizing, by the at least one processor, a cloud-based functionality to dynamically connect at least two entities based on a determination of the set of artifacts shared between the at least two entities;
dynamically integrating, by the at least one processor and in response to connecting the at least two entities, a plurality of protocols into an interaction session associated with the at least two entities,
wherein the plurality of protocols associated with the interaction session comprise requirements to connect received from each entity of the plurality of entities;
utilizing, by the at least one processor, at least one machine learning module to analyze a particular data sleeve associated with each entity,
wherein the particular data sleeve contains protocol preferences and predetermined artifact transfer rules associated with each entity;
verifying, by the at least one processor, the plurality of protocols associated with the interaction session,
wherein verifying the plurality of protocols comprising ensuring a number of shared requirements from the plurality of entities exceed a predetermined threshold;
initiating, by the at least one processor, the interaction session between at least two entities based on the plurality of protocols and the set of artifacts;
utilizing, by the at least one processor, an enterprise integration services layer module to predict a likelihood associated with a successful transfer of a particular artifact between the at least two entities;
automatically modifying, by the at least one processor, the interaction session to orchestrate a transfer of at least one artifact of the set of artifacts between the at least two entities; and
systemically capturing at least one predicted artifact transfer of a particular artifact that fails to match the verified plurality of protocols; and
generating a plurality of systematic reports associated with a plurality of predicted artifact transfers and requests for artifact transfers that are automatically verified within the predetermined period of time.

19. The method of claim 18, further comprising:
utilizing the interaction constraint module to receive plurality of artifact transfers related inputs;
utilizing an allocation recon tool to comparing the plurality of artifact transfers to a plurality of transfer related inputs to determine additional inputs and common artifacts transfers associated with the interaction session;
utilizing a machine learning module to identify a plurality of data breaks associated with a comparison of the plurality of artifact transfers to the plurality of transfer related inputs;
automatically tracing an age associated with each request of the plurality of artifact transfers within an external database; and
generating a plurality of systemic notices to ensure the plurality of artifact transfers are submitted within a predetermined period of time.

20. A system comprising:
a non-transient computer memory, storing software instructions;
at least one processor of a computing device associated with an entity;
wherein, when the at least one processor executes the software instructions, the computing device is programmed to:
identify a plurality of entities seeking to interact with each other;
determine a set of artifacts associated with each entity of the plurality of entities;
utilize a cloud-based functionality to dynamically connect at least two entities based on a determination of the set of artifacts shared between the at least two entities;
dynamically integrate, and in response to connecting the at least two entities, a plurality of protocols into an interaction session associated with the at least two entities,
wherein the plurality of protocols associated with the interaction session comprise requirements to connect received from each entity of the plurality of entities;
verify the plurality of protocols associated with the interaction session,
wherein a verification of the plurality of protocols comprising ensuring a number of shared requirements from the plurality of entities exceed a predetermined threshold;
initiate the interaction session between at least two entities based on the plurality of protocols and the set of artifacts; and
automatically modify the interaction session to orchestrate a transfer of at least one artifact of the set of artifacts between the at least two entities.
